(19) United States
(12) Patent Application Publication
(10) Pub. No.: US 2003/0214708 A1
(43) Pub. Date: Nov. 20, 2003

(54) Telescope

(76) Inventors: Norbert Muller, Asslar (DE); Gerd Polzer, Wetzlar-Hermannstein (DE); Volker Claudi, Lahnau-Dorlar (DE)

Correspondence Address: M. Robert Kestenbaum, 11011 Bermuda Dunes NE, Albuquerque, NM, 87111, US

(21) Appl. No.: 10/408,324

(22) Filed: Apr. 6, 2003

(30) Foreign Application Priority Data
Apr. 16, 2002 (DE) DE 102 16 993.4

(51) Int. Cl. G02B 23/00

(52) U.S. Cl. 359/399

(57) ABSTRACT

A telescope with an optical axis established by the optical elements of the telescope, comprising an eyepiece, an objective and a first focusing optics, which is mounted displaceably along the optical axis for focusing, wherein the telescope has a second focusing optics which is mounted displaceably along the optical axis for focusing.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a telescope, comprising an eyepiece, an objective and an axially displaceable focusing optics arranged between the eyepiece and the objective.

From DE 42 31 655 C1, a monocular telescope in known, which has an eyepiece, an objective and an axially displaceable focusing optics arranged between the eyepiece and the objective. Furthermore this telescope is provided with an actuating element, which can be connected to the focusing optics by means of a gearbox. By the selection of one of the gear ratios, the speed is selectable at which the focusing optics is moved in the direction of the optical axis for an identical movement of the actuating element.

From the 1998 brochure of the Leica company, with the order number of the issue 910596, a monocular telescope is known which has a coarse drive and a fine drive for adjusting the focus, for focusing to a range of between 3.95 m and on.

From U.S. Pat. No. 4,296,793, a telescope is known which relates to both monocular and binocular telescopes. The telescope known from this document had the object of providing a telescope with a variable magnification with improved optical properties. This object was attained by providing an axially displaceable lens arranged behind the objective in the direction from the objective to the eyepiece, instead of changing the magnification by means of the eyepiece. The objective group L11 is a focusing group and is thus also mounted for displacement in the axial direction.

A prism arrangement for restoring image orientation is provided behind the axially displaceable lens L12 for adjusting the magnification. A compensation group is arranged behind the prism arrangement, and is displaced in the axial direction together with the lens for changing the magnification. A diaphragm and an eyepiece are arranged after the compensation group.

From DE 42 44 161 A1, binoculars are known whose magnification is adjustable by means of a variable focus eyepiece. The focused state is not altered when the magnification is adjusted. Furthermore, the binoculars have a focusing performed by means of axially displaceable lenses in the objective. A diopter equalization is coupled to the focusing; an axially displaceable lens being displaced axially, and the further lens arranged for focusing in the second objective of the binoculars does not change its position.

A motor drive for focusing can be actuated by pressing the focusing switch.

Either a motor or a manual drive can be provided for adjusting the magnification. The motor drives are respectively provided with a friction clutch in order to avoid overloading the mechanism. The magnification adjustment is provided with a releasable coupling so that manual adjustment of the magnification is possible for setting the same magnifications of the two telescope systems of the binoculars. An adjusting method is concerned here.

The invention has as its object to enlarge the range to which focusing is possible.

Furthermore of the invention has the object of making possible rapid switching back and forth between focusing to a great distance and focusing to a near distance.

### SUMMARY OF THE INVENTION

The object of the invention is attained by a telescope with an optical axis established by the optical elements of a telescope, including an eyepiece, an objective, and a first focusing optics, which is mounted displaceably along the optical axis for focusing, wherein the telescope has a second focusing optics, which is mounted displaceably along the optical axis for focusing. By the measure that a telescope is to be provided with a first and a second focusing optics, the focusing range of the telescope could be increased. A first focusing range is established by the first focusing optics, and a second focusing range is established by the second focusing optics; by the mutually adjacent existence of these two focusing ranges, the magnification of one of these two focusing ranges results. The first and the second focusing optics are mounted displaceably along the optical axis. Focusing can be effected by displacement of the first and/or the second focusing optics along the optical axis.

In an advantageous embodiment, it is provided to arrange one of the focusing optics between the eyepiece and the objective.

It has furthermore been found to be advantageous to arrange one of the focusing optics in the objective.

Furthermore, it can be more advantageous to arrange one of the focusing objects in the eyepiece.

In particular, it has been found to be advantageous to arrange the second focusing optics either in the objective or in the eyepiece.

It has been found to be advantageous to allocate a first control element to the first focusing optics and a second control element to the second focusing optics.

In an advantageous embodiment, the second control element is constituted as an adjusting ring, which is arranged coaxially of the optical axis.

In particular, it has been found to be advantageous to convert a movement brought about by the adjusting ring into an axial movement of the focusing optics by means of a cam drive arranged between the adjusting ring and the focusing optics.

In an advantageous embodiment, it is provided that a motor for driving at least one of the focusing assemblies is provided. In particular, the motor is preferably a linear motor.

In an advantageous embodiment, it is provided that a focusing optics is continuously displaceable between two stop positions.

Furthermore, it has been found to be advantageous that one of the focusing optics is adjustable to preferred positions by means of detents, which are provided.

Preferably one of the focusing optics is continuously adjustable and the other to preferred positions by means of the detents, which are provided. By the provision of detents, it is possible to quickly change in predefined large steps between different focus planes. In particular, it has been found to be advantageous to provide a continuous focusing for a fine focusing.

In an advantageous development, the first control element preferably has a coarse drive for displacement of the first focusing optics at a high speed and a fine drive for driving the first focusing optics at a lower speed. Thus on the one hand focusing can be performed by means of the second focusing optics and in addition, focusing by the first focusing optics can be performed by means of the coarse and fine drive. There are thus three control elements available for focusing. By means of one of the control elements for focusing, it is in particular possible to change suddenly and quickly from a focus plane in the far region to a focus plane in the near region.

It has been found to be advantageous to provide the objective with a protective disk on the object side. The telescope can be protected from dirt and dust by means of this protective disk. Furthermore, the telescope can be sealed by means of this protective disk and it can thereby be ensured that the gas volume enclosed between this protective disk and the eyepiece remains constant.

It has been found to be advantageous to mount the adjusting ring rotatably, and fixed axially.

It can thereby be ensured that no lack of sealing arises due to the adjusting ring in relation to gas and liquid during the whole time the telescope is in use. By this measure of axially fixed mounting of the adjusting ring, transverse forces are prevented from arising on the seals provided for the adjusting ring. Stress and wear on the seals are thereby greatly reduced.

It has been found to be advantageous to provide the objective with a glare protector which can be pulled out axially. By this measure, the user is given the means of simply pulling the glare protector out when glare arises. Handling is thereby considerably simplified, since otherwise the telescope user has to bring the usual glare protector with him as an accessory and then also mount it beforehand.

It has been found to be advantageous for the telescope to have a constant constructional length without considering the glare protector. Thus the gas volume enclosed within the telescope remains constant as long as the telescope is gastight.

It is provided in an advantageous embodiment that the objective lens group is adjustable to preferred positions by means of detents. The user can thereby rapidly change by a predetermined amount between predetermined focus planes by displacing the position of the objective lens group by a predetermined amount. Furthermore, a region in which continuous displacement of the objective lens group is possible can be provided between the preferred positions. Stops are allocated to the displacement of focusing by means of the objective lens group, and signal a displacement by a predetermined amount to the user.

### BRIEF DESCRIPTION OF THE DRAWINGS

The invention is described in detail hereinafter using an example:

FIG. 1 shows the telescope in the form of a monocular telescope, in longitudinal section;

FIG. 2 shows a longitudinal section through the objective;

FIG. 3 shows a diagram of lens sections for different focusing positions.

### DETAILED DESCRIPTION OF THE INVENTION

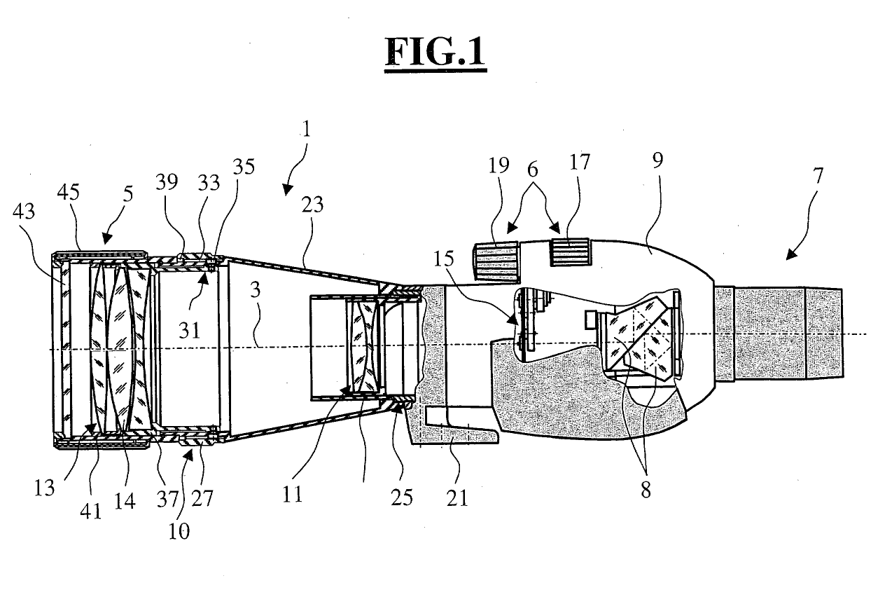

The principal construction is described in principle using FIG. 1 for the case of a monocular telescope 1. The monocular telescope 1 has an objective 5 and an eyepiece 7. The eyepiece 7 is interchangeable and is provided with a mechanism for connecting to a housing 9 of the telescope 1, as described in DE 10121439, which is incorporated herein by reference. In particular, the eyepiece can also be a variable focus eyepiece.

A first focusing optics 11 is axially displaceably mounted in the housing 9. In the example shown, the first focusing optics is arranged between the eyepiece and the objective. For displacement of the first focusing optics 11, a coarse drive 17 and a fine drive 19 are provided as the first control element 6, and are connected via gearing 15 to the first focusing optics 11. The construction and the manner of functioning of the coarse and fine drives are described in detail in DE 10121074, which is incorporated herein by reference.

The housing 9 has, on the side facing toward the objective 5, an outer profile 25, by means of which an objective housing 23 having a corresponding inner profile 24 on the side facing toward the eyepiece 7 can be connected to the housing 9. Furthermore the telescope is provided with a tripod fastening 21 in a middle region. It could also be provided to connect the objective housing 23 at one end to the tripod fastening 21, which in its turn is connected at the other end to the housing 9. The embodiment shown has the advantage over the previously described embodiment that connection places are minimized.

The objective housing 23 has a conical region into which the first focusing optics 11 projects. A tube-shaped region of the objective housing 23 adjoins this conical region, and is coaxially surrounded by an adjusting ring 27 as the second control element 10. The adjusting ring 27 is provided on its radial inner side with an axial guide 33 in which a guide pin 35 of a cam drive 31 engages. The guide pin 35 is fixedly connected to a mount 37 of an objective lens group 13, which is guided by an objective tube 41. In this example, the objective lens group 13 represents the second focusing optics 12. The objective 5 can have further objective lenses, preferably mounted in a fixed location, in addition to this displaceable objective lens group 13.

The objective housing 23 is fixedly connected to the object tube 41 on the side facing toward the object. The adjusting ring 27 is axially guided by this objective tube, so that the adjusting ring 27, when it rotates, cannot change its position with respect to the axial direction of the telescope. Seals 39 are provided to ensure sealing. Thus, since the adjusting ring 27 does not execute any movement in the axial direction, no transverse forces are transmitted to these seals.

A cam track in the form of a recess in which the guide pin 35 can move is formed in the objective housing 23 in the region between the adjusting ring 27 and mount 37. An axial guide could just as well be formed in the housing 23 of the objective and the guide cam track for guiding the guide pin 35 could be formed on the inside of the adjusting ring. Further arrangements of the axial guide and guide cam are conceivable.

Instead of the actuation of the adjusting ring 27 for axial displacement of the objective lens group 13, a motorized adjusting drive, not shown, could also be provided. A corresponding axial movement of the objective lens group 13 could be executed by the motorized adjusting drive, by actuation of an actuating button, not shown. The use of linear motors is advantageous for such an application, since the movement of a linear motor can be used without a gear being necessary to convert a rotational movement into a linear movement. Such linear motors, which are distinguished by a low energy consumption, are already available as standard components.

The objective tube 41 is coaxially surrounded by a glare protector 45 on the side facing toward the object. The glare protector 45 is mounted for axial displacement on the tube 41. So that the set position of the glare protector 45 is not inadvertently changed, friction elements 47, such as felt, for example, are provided. A maximum pulled-out position of the glare protector 45 is ensured by a projection 49 formed on the objective tube 41 and a projection 51 formed on the glare protector 45, which strike against each other at the maximum pulled-out position of the glare protector 45. A ring element 44 is provided for fixing a protective disk 43, and is fixedly connected to the objective tube 41.

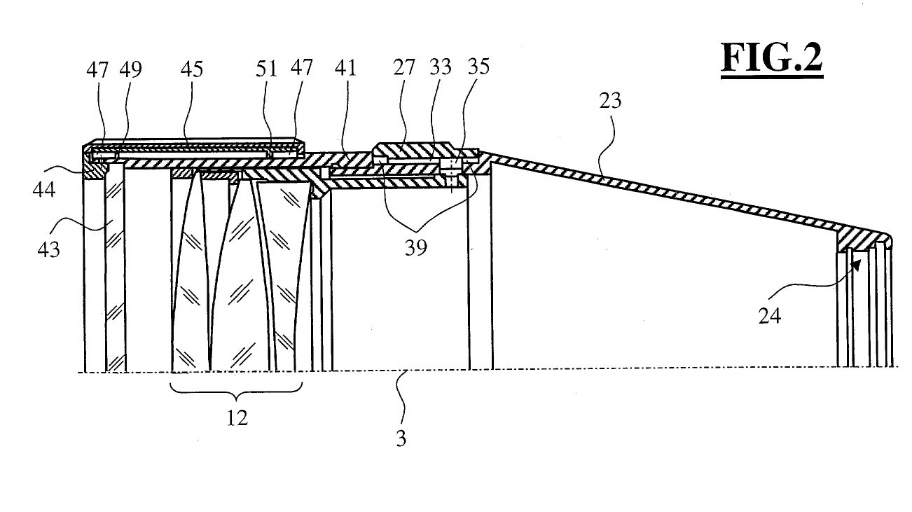

In FIG. 2, an enlarged section through the objective is shown, in which the adjusting ring 27 with the cam drive 31 is more easily seen, in particular. Such an adjusting ring could also be provided as the first control element.

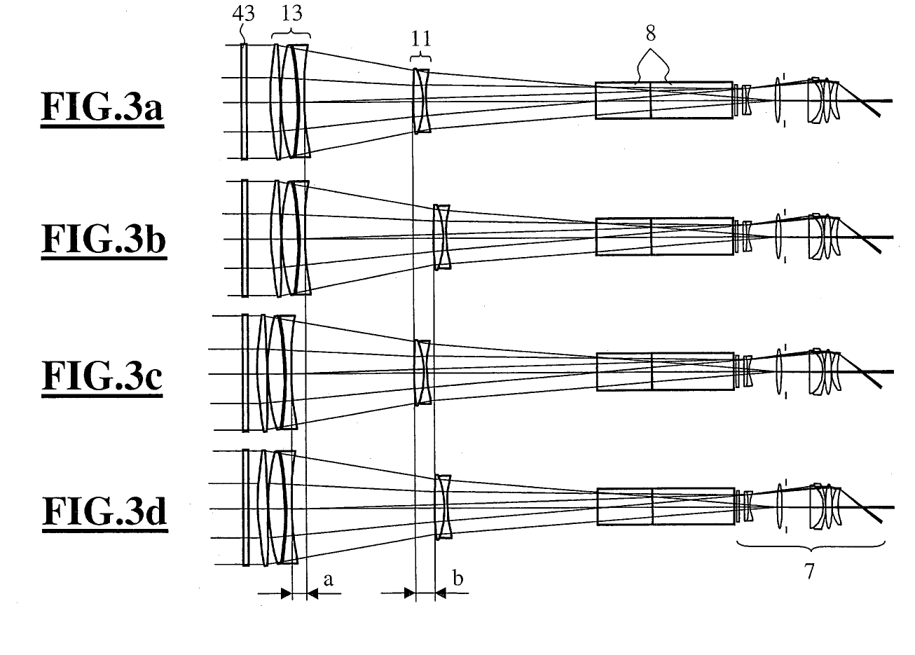

In FIG. 3a, the position of the lenses is shown in which focusing is to infinity. The lenses of the eyepiece are denoted by 7. The prisms 8 adjoin which were already shown in FIG. 1. The lenses of the first focusing optics 11 are situated in the most object-side position which they can assume. The objective lens group 13 is situated in the most eyepiece-side position which it can assume.

In FIG. 3b, the first focusing optics 11 is arranged in the position nearest to the eyepiece. The objective lens group 13 is furthermore arranged in the position with the smallest possible distance to the eyepiece 7 or to the prism arrangement 8. Focusing is to a range distance of 5 meters with this lens arrangement.

In FIG. 3c, focusing is to a range of 6.7 meters. The lenses of the objective group 13 are arranged in the furthest possible position from the prism arrangement 8. The focusing optics is likewise arranged in the furthest possible position from the prism arrangement 8.

In the lens arrangement shown in FIG. 3d, focusing is to a range of 3 meters. The objective lens group 13 is situated in the position arranged as far as possible from the prisms, and the focusing optics 11 is in the closest possible position to the prisms 8.

As can be seen from FIGS. 3a-3d, it was possible to increase the focusing range in this specific example from one of infinity to 5 meters to one of infinity to 3 meters, by the axial displaceability of the objective lens group 13. This increase of the focusing range in this telescope is not associated with any worsening of the optical imaging quality due to the axial displacement of the objective lens group 13.

Reference List

1 telescope, monocular telescope 23 objective housing

3 optical axis 24 inner profile

5 objective 25 outer profile

6 first control element 27 adjusting ring

7 eyepiece 31 cam drive

8 prisms 33 axial guide

9 housing 35 guide pin

10 second control element 37 mount

11 first focusing optics 39 seal

12 second focusing optics 41 objective tube

13 objective lens group 43 protective disk

14 objective lens 44 ring element

15 gearing 45 glare protector

17 coarse drive 47 friction element

19 fine drive 49 projection

21 tripod 51 projection

What is claimed is:

1. A telescope with an optical axis established by the optical elements of the telescope, including an eyepiece, an objective, and a first focusing optics, which is mounted displaceably along the optical axis for focusing, wherein the telescope has a second focusing optics which is mounted displaceably along the optical axis for focusing.

2. The telescope according to claim 1, wherein one of the focusing optics is arranged between the eyepiece and the objective.

3. The telescope according to claim 1, wherein one of the first or second focusing optics is arranged in the objective.

4. The telescope according to claim 1, wherein a first control element is allocated to the first focusing optics, and a second control element is allocated to the second focusing optics.

5. The telescope according to claim 4, wherein an adjusting ring is provided as the second control element, and is arranged coaxially of the optical axis.

6. The telescope according to claim 5, wherein the adjusting ring is connected via a cam drive to the second focusing optics.

7. The telescope according to claim 1, comprising a motor that drives at least one of the focusing optics.

8. The telescope according to claim 7, wherein the motor comprises a linear motor.

9. The telescope according to claim 1, wherein at least one of the focusing optics is continuously displaceable between two stop positions.

10. The telescope according to claim 1, comprising a set of detents wherein one of the focusing optics is settable to preferred positions of the set of detents.

11. The telescope according to claim 1, wherein the objective has a protective disk on its object side.

12. The telescope according to claim 5, wherein the adjusting ring is rotatably mounted and axially fixed.

13. The telescope according to claim 1, wherein the objective comprises a glare protector which is pulled out in an axial direction.

14. The telescope according to claim 1, wherein the telescope without a glare protector has a constant constructional length.

15. The telescope according to claim 5, comprising a coarse drive the drives the first focusing optics at high speed, and a fine drive that drives the first focusing optics, are provided as the first control element, operatively connected to the first focusing optics by gearing.

16. The telescope according to claim 1, wherein the telescope comprises a monocular field glass.

17. The telescope according to claim 15, wherein the first focusing optics is arranged between the eyepiece and the objective.
